(19) United States
(12) Patent Application Publication
(10) Pub. No.: US 2004/0109992 A1
(43) Pub. Date: Jun. 10, 2004

(54) Process for applying a polyurethane dispersion based foam to an article

(76) Inventors: Michael Y. Gribble, Wollerau (CH); James G. Kennedy, Hulst (NL); Douglas P. White, Lake Jackson, TX (US); Paulus C.J.M. Van Bellegem, Philippine (NL); Randal E. Autenrieth, Lake Jackson, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/314,854

(22) Filed: Dec. 9, 2002

(51) Int. Cl. B32B 3/00; B32B 5/02; B32B 9/00; B32B 9/04; B32B 27/12; B32B 5/18; B32B 5/24; B32B 3/26

(52) U.S. Cl. 428/315.9; 428/304.4; 442/157; 442/59

(57) ABSTRACT

Disclosed is a process for making a two or more component foam composite obtained by adhesion of a polyurethane foam onto a substrate comprising the steps of frothing an aqueous polyurethane formulation; applying the froth to a substrate and drying the froth into a foam wherein the foam has a dry density of 35 kg/m³ to 160 kg/m³ (2.2-10 lbs/cft). The process allows the production of foam backed textiles without the need for a flame lamination step or the need for an adhesive layer between the textile and the foam layer and is optionally optimized for superior handling properties for covering polyurethane molded foam cushions.

### FIELD OF THE INVENTION

This invention relates to a substrate with back-coated thin layer of polyurethane foam, and to articles containing such a substrate. More particularly, the invention relates to a composite cover material comprising roll goods consisting of a fabric, textile or plastic having a thin layer of foamed polyurethane adhered to its back or inner surface, and to a process for preparing the same.

### BACKGROUND OF THE INVENTION

Foam backed materials, particularly fabrics, are used in a variety of applications, such as automotive applications e.g., vehicle seats, seat cushions, headrests, headliners, armrests, sun visors, door panels, parcel shelves, and for use in upholstry of furniture, bedding and apparel. Foam backed fabrics can also be useful as cushion or absorbent layers for various textiles and disposable goods.

Such foam backed fabrics are generally prepared in several steps. Initially a foam is prepared by reacting a polyisocyanate and a polyol and other auxiliary components under conditions known to those skilled in the art and then the foam is sliced or peeled to a desired thickness. In order to adhere the foam to a fabric, the fabric can be optionally impregnated with a water borne polymeric binder, typically an acrylic based polymer, to provide dimensional stability and suitable hardness and subsequently in a separate process the treated fabric is joined to the skived foam by flame lamination or by adhesive bonding.

The flame lamination process and the adhesive bonding process involve several manufacturing operations that take place at different locations, e.g., the manufacturer shipping the fabric to the flame laminator or adhesive bonder, who may or may not also be the foamer, the composite fabric is then shipped back to be cut and sewn as a seat cover and/or assembled as a seat before being shipped to the automotive OEM. In addition to the logistics, the flame lamination and adhesive bonding processes have disadvantages related to emissions of volatile organic compounds either from the decomposition of the molten polyurethane polymer in the case of flame lamination process or the release of organic solvent from the adhesive bonding process.

Alternatively a soft foam article having a cover integrally adhered thereto can be produced by providing a permeable cover fabric in the shape of a desired final article and pouring onto the shaped cover fabric placed in the mold, a reactive foaming polyurethane formulation to form a molded foam which is integrally adhered with the cover fabric. Undesireable foam properties can result from the poured material permeating into or through the cover fabric. When the liquid stock material is applied directly onto the inside surface of the permeable fabric breakthrough seepage can occur prior to and during the chemical and thermal foaming which causes partially stiffened areas or hard spots in the fabric that are unpleasant to the touch and do not meet automotive quality specifications.

Alternatively, for the purpose of avoiding penetration or impregnation of the body foam into the cover fabric, techniques to apply an airtight film on the inside surface of the cover fabric are proposed in various United States patents. For example, U.S. Pat. Nos. 4,247,347, 4,247,348, 4,264,386 and 4,287,143 disclose applying of airtight films, preferably polyvinylchloride film, to the back surface of the cover fabric. Such airtight or impermeable films, however, deprive the finished foamed article of the permeability and breathability which leads to an uncomfortable feeling, such as a moist or sticky touch on the surface of the article. To avoid some of this disadvantages, it is proposed in U.S. Pat. No. 5,460,873 to prepare a composite cover material by using a thin layer of latex foam bonded to the fabric. Lack of significant commercialization of this latter invention can be explained by inadequate property performance profiles of previously available foam systems, such as styrene butadiene polymers, at cost competitive densities whereas use of higher densities contributes prohibitive weight increase.

It would therefore be advantagous to have a simplified process for producing a compositie material having a foamed backing with greater operational efficiency and reduced volatile emissions generated during production. Particularly a process that creates a suitable product and avoids the need for multistep process including a flame lamination process, adhesive bonding or the need to have a non-permeable layer associated with the substrate. It would also be advantageous for such produced articles to have combustion modified properties that allow for greater freedom of choice of fabric used for covers while still meeting the OEM requirements.

### SUMMARY OF THE INVENTION

In one aspect the, invention is a process for making a two or more component foam composite obtained by adhesion of a polyurethane foam onto a substrate comprising the steps of frothing a formulated aqueous polyurethane dispersion; applying the froth to a substrate and drying the froth into a foam wherein the foam has a dry density of 35 kg/m³ to 160 kg/m³ (2.2-10 lbs/cft).

In another aspect the invention is a process for making a two or more component composite, without the use of flame lamination process or use of adhesive binder layers, comprising the steps of frothing a formulated aqueous polyurethane dispersion; applying the froth to a textile and drying the froth into a foam wherein the foam has a dry density of 35 kg/m³ to 160 kg/M³ (2.2-10 lbs/cft) and the foam composite meets combustion modification test FMVSS 302

In a further aspect, the invention is the production of a foam composite where a flame retardant is added to a polyurethane dispersion in a sufficient amount so that upon preparing a foam from such dispersion, the foam meets combustion modification test FMVSS 302. Additional components can be added to the polyurethane dispersion such that the final dispersion contains 50 to 95 parts by weight of dry solids.

In an additional aspect, the invention is the production of a foam composite where the surface properties of the foam are suitably modified to enhance the coefficient of friction at the surface for improved ease of handling when manipulating the fabric in end use applications such as automotive seating. Such a modification of the surface properties of the foam can be achieved in several different ways. Firstly, addition of suitable additives such as waxes to the formulated polyurethane dispersion or compound, prior to frothing, lead to blooming of the wax to the surface of the foam during the drying stage, increasing the slickness of the surface. Secondly, application of a water based spray coating, such as a silicone, to the surface of the dried foam on exiting the oven which dries to a slippery film on the foam surface of the hot or warm composite prior to winding up the roll goods into roll stock. Thirdly, a hot lamination of a thin film, such as a light weight non-woven polyethylene like “pink poly”, (INTEGRAL™ 899 and DAF™ 780, available from The Dow Chemical Company), directly to the surface of the dried foam surface through a nip roller after exiting the drying oven and prior to winding up the roll goods into roll stock. Fourthly, a fabric can be laid onto the wet froth prior to drying of the wet froth and the complete composite is dried in a single pass drying step.

### DETAILED DESCRIPTION

In one embodiment, the present invention is a process for producing a foam composite by adhesion of a polyurethane foam on to a substrate by applying a polyurethane froth to the substrate. When the substrate is a textile, the process eliminates the need for a flame lamination process or the need for a binder or adhesion layer between the textile and the separately produced skived foam. The present process also eliminates the need to have a non-permeable layer between a permeable textile and the applied formulation of a foam in order to avoid or reduce rough fabric due to the seepage of the formulation into the fabric. The elimination of the flame lamination process reduces the number of steps required in producing the foam composite and avoids emissions associated with the flame lamination process. With the addition of certain selected flame retardants, it was unexpectedly found the composite materials meet certain mandated flame retardant properties without the need for the presence of a halogenated flame retardant.

It was surprisingly found that a water based polyurethane dispersion can be formulated with 35 to 80 parts by weight solids while still obtaining a final foam density as low as 35 to 40 kg/m³ and a resiliency of 10-50%. It was further discovered that the composites produced from such a dispersion, combined with a combustion modifying agent, can meet combustion modification test FMVSS 302.

The use of such polyurethane dispersions are advantageous over other aqueous polymer systems, such as styrene-butadiene latexes. Such latexes are well known to be able to provide mechanically frothed foams. However, the physical properties of low density materials obtained from these dispersion do not meet the performance requirements of incumbent flame laminated or adhesively bonded products.

A polyurethane dispersion useful in the practice of the present invention includes water, and either: a polyurethane; a mixture capable of forming a polyurethane; or and surfactants. Polyurethane-forming materials as used in the present invention are materials which can be used to prepare polyurethane polymers. Polyurethane-forming materials include, for example, polyurethane prepolymers. While polyurethane prepolymers may retain some isocyanate reactivity for some period of time after dispersion, for purposes of the present invention, a polyurethane prepolymer dispersion shall be considered as being a fully reacted polyurethane polymer dispersion. Also, for purposes of the present invention, a polyurethane prepolymer or polyurethane polymer can include other types of structures such as, for example, urea groups.

Polyurethane prepolymers useful in the practice of the present invention are prepared by the reaction of active hydrogen compounds with any amount of isocyanate in a stoichiometric excess relative to active hydrogen material. Isocyanate functionality in the prepolymers useful with the present invention can be present in an amount of from 0.2 weight percent to 20 weight percent. A suitable prepolymer can have a molecular weight in the range of from 100 to 10,000. Prepolymers useful in the practice of the present invention should- be substantially liquid under the conditions of dispersal.

The prepolymer formulations of the present invention include a polyol component. Active hydrogen containing compounds most commonly used in polyurethane production are those compounds having at least two hydroxyl groups or amine groups. Those compounds are referred to herein as polyols. Representatives of suitable polyols are generally known and are described in such publications as High Polymers, Vol. XVI, “Polyurethanes, Chemistry and Technology” by Saunders and Frisch, Interscience Publishers, New York, Vol. I, pp. 32-42, 44-54 (1962) and Vol. II, pp. 5-6, 198-199 (1964); Organic Polymer Chemistry by K. J. Saunders, Chapman and Hall, London, pp. 323-325 (1973); and Developments in Polyurethanes, Vol. I, J. M. Burst, ed., Applied Science Publishers, pp. 1-76 (1978). However, any active hydrogen containing compound can be used with the present invention. Examples of such materials include those selected from the following classes of compositions, alone or in admixture: (a) alkylene oxide adducts of polyhydroxyalkanes; (b) alkylene oxide adducts of non-reducing sugars and sugar derivatives; (c) alkylene oxide adducts of phosphorus and polyphosphorus acids; and (d) alkylene oxide adducts of polyphenols. Polyols of these types are referred to herein as “base polyols”. Examples of alkylene oxide adducts of polyhydroxyalkanes useful herein are adducts of ethylene glycol, propylene glycol, 1,3-dihydroxypropane, 1,4-dihydroxybutane, and 1,6-dihydroxyhexane, glycerol, 1,2,4-trihydroxybutane, 1,2,6-dihydroxyhexane, 1,1,1-trimethylolethane, 1,1,1-trimethylolpropane, pentaerythritol, polycaprolactone, xylitol, arabitol, sorbitol, mannitol. Preferred herein as alkylene oxide adducts of polyhydroxyalkanes are the propylene oxide adducts and ethylene oxide capped propylene oxide adducts of dihydroxy- and trihydroxyalkanes. Other useful alkylene oxide adducts include adducts of ethylene diamine, glycerin, piperazine, water, ammonia, 1,2,3,4-tetrahydroxy butane, fructose, sucrose. Also useful with the present invention are poly(oxypropylene) glycols, triols, tetrols and hexols and any of these that are capped with ethylene oxide. These polyols also include poly(oxypropyleneoxyethylene)polyols. The oxyethylene content should preferably comprise less than about 80 weight percent of the total polyol weight and more preferably less than about 40 weight percent. The ethylene oxide, when used, can be incorporated in any way along the polymer chain, for example, as internal blocks, terminal blocks, or randomly distributed blocks, or any combination thereof.

Polyester polyols can be used to prepare the polyurethane dispersions of the present invention. Polyester polyols are generally characterized by repeating ester units which can be aromatic or aliphatic and by the presence of terminal primary or secondary hydroxyl groups, but any polyester terminating in at least 2 active hydrogen groups can be used with the present invention. For example, the reaction product of the transesterification of glycols with poly(ethylene terephthalate) can be used to prepare the dispersions of the present invention.

For the polyurethane dispersions, preferably at least 50 weight percent of the active hydrogen compounds used to prepare the polyurethane or polyurethane prepolymer is a polyether polyol having a molecular weight of from 600 to 20,000, preferably 1,000 to 10,000, most preferably 3,000 to 8,000. Preferably the polyol has a hydroxyl functionality of at least 2.2. Preferably this polyol has a hydroxyl functionality of from 2.2 to 5.0, more preferably from 2.3 to 4.0 and even more preferably from 2.5 to 3.8. Most preferably, the active hydrogen compounds used to prepare the polyurethane or polyurethane prepolymer is a polyether polyol having a hydroxyl functionality of from 2.6 to 3.5 and a molecular weight of from 3,000 to 8,000. For purposes of the present invention, functionality is defined to mean the average calculated functionality of all polyol initiators further adjusted for any known side reactions which affect functionality during polyol production.

The polyisocyanate component of the formulations of the present invention can be prepared using any organic polyisocyanates, modified polyisocyanates, isocyanate based prepolymers, and mixtures thereof. These can include aliphatic and cycloaliphatic isocyanates, but aromatic and especially multifunctional aromatic isocyanates such as 2,4- and 2,6-toluenediisocyanate and the corresponding isomeric mixtures; 4,4′-, 2,4′- and 2,2′-diphenyl-methanediisocyanate (MDI) and the corresponding isomeric mixtures; mixtures of 4,4′-, 2,4′- and 2,2′-diphenylmethanediisocyanates and polyphenyl polymethylene polyisocyanates (PMDI); and mixtures of PMDI and toluene diisocyanates are preferred. Most preferably, the polyisocyanate used to prepare the prepolymer formulation of the present invention is MDI or PMDI or crude mixtures of any of these.

The prepolymers for use in the present invention include a chain extender or crosslinker. A chain extender is used to build the molecular weight of the polyurethane prepolymer by reaction of the chain extender with the isocyanate functionality in the polyurethane prepolymer, that is, chain extend the polyurethane prepolymer. A suitable chain extender or crosslinker is typically a low equivalent weight active hydrogen containing compound having about 2 or more active hydrogen groups per molecule. Chain extenders typically have 2 or more active hydrogen groups while crosslinkers have 3 or more active hydrogen groups. The active hydrogen groups can be hydroxyl, mercaptyl, or amino groups. An amine chain extender can be blocked, encapsulated, or otherwise rendered less reactive. Other materials, particularly water, can function to extend chain length and, therefore, can be chain extenders for purposes of the present invention.

Polyamines are preferred chain extenders and/or crosslinkers. It is particularly preferred that the chain extender be selected from the group consisting of amine terminated polyethers such as, for example, JEFFAMINE D-400 from Huntsman Chemical Company, aminoethyl piperazine, 2-methyl piperazine, 1,5-diamino-3-methyl-pentane, isophorone diamine, ethylene diamine, diethylene triamine, aminoethyl ethanolamine, triethylene tetraamine, triethylene pentaamine, ethanol amine, lysine in any of its stereoisomeric forms and salts thereof, hexane diamine, hydrazine and piperazine. In the practice of the present invention, the chain extender can be used as an aqueous solution.

In the formation of the dispersion, a chain extender is employed in an amount sufficient to react with from zero (0) to 100 percent of the isocyanate functionality present in the prepolymer, based on one equivalent of isocyanate reacting with, one equivalent of chain extender. It can be desirable to allow water to act as a chain extender and react with some or all of the isocyanate functionality present. A catalyst can optionally be used to promote the reaction between a chain extender and an isocyanate. When chain extenders of the present invention have more than two active hydrogen groups, then they can also concurrently function as crosslinkers.

Surfactants useful for preparing a stable dispersion can be cationic surfactants, anionic surfactants, or a non-ionic surfactants. Examples of anionic surfactants include sulfonates, carboxylates, and phosphates. Examples of cationic surfactants include quaternary amines. Examples of non-ionic surfactants include block copolymers containing ethylene oxide, propylene oxide, butylene oxide, or a combination thereof and silicone surfactants.

Surfactants useful in a polyurethane dispersion can be either external surfactants or internal surfactants. External surfactants are surfactants which do not become chemically reacted into the polymer during dispersion preparation. Examples of external surfactants useful herein include salts of dodecyl benzene sulfonic acid, and lauryl sulfonic acid salt. Internal surfactants are surfactants which do become chemically reacted into the polymer during dispersion preparation. An example of an internal surfactant useful herein includes 2,2-dimethylol propionic acid (DMPA) and its salts or sulfonated polyols neutralized with ammonim chloride. A surfactant can be included in a formulation of the present invention in an amount ranging from 0.01 to 8 parts per 100 parts by weight of polyurethane component.

Currently most commercially available polyurethane dispersions contain DMPA as an internal surfactant and can be utilized in this invention. In contrast a family of polyurethane dispersion which do not contain DMPA, rather incorporating non-ionic modifiers based on ethylene oxide as internal surfactants are equally suitable for practicing this invention, providing other technical and commercial advantages to the process. See for example U.S. Pat. No. 6,271,276.

Generally, any method known to one skilled in the art of preparing polyurethane dispersions can be used. A suitable storage-stable polyurethane dispersions as defined herein is any polyurethane dispersions having a mean particle size of less than about 5 microns. A polyurethane dispersions that is not storage-stable can have a mean particle size of greater than 5 microns. For example, a suitable dispersion can be prepared by mixing a polyurethane prepolymer with water and dispersing the prepolymer in the water using a mixer. Alternatively, a suitable dispersion can be prepared by feeding a prepolymer into a static mixing device along with water, and dispersing the water and prepolymer in the static mixer. Continuous methods for preparing aqueous dispersions of polyurethane are known and can be used in the practice of the present invention. For example, U.S. Pat. Nos.: 4,857,565; 4,742,095; 4,879,322; 3,437,624; 5,037,864; 5,221,710; 4,237,264; and 4,092,286 all describe continuous processes useful for preparing polyurethane dispersions. In addition, a polyurethane dispersion having a high internal phase ratio can be prepared by a continuous process such as is described in U.S. Pat. No. 5,539,021.

A polyurethane formulation suitable for preparing a foam for use in the present invention (hereinafter Compound) can be prepared from a polyurethane dispersion and foam frothing and stabilizing surfactants. It has been surprisingly found that by using a selection of frothing and stabilizing surfactants or combination thereof, that one can obtain a lower density foam while maintaining desired foam properties like abrasion resistance, tensile, tear, and elongation (TTE), compression set, foam recovery, wet strength, toughness, and adhesion to substrate. Since optimizing one property will effect the values of the other properties, one skilled in the art can vary the ranges of these properties to maintain a combination of acceptable values. For example, for a foam having a density of approximately 35 kg/m³, generally industrial acceptable foam properties include a resilience of greater than 30% as measured by ASTM D-3574, minimum tensile strength (MPa) of 78 as measured by ASTM D-3574; and an elongation of greater than 120% as measured by ASTM D-3574. For a foam having a density of approximately 40 kg/m³, generally industrial acceptable foam properties include a resilience of greater than 28%, a minimum tensile strength (MPa) of 196; and an elongation of greater than 140%.

In general, the foam prepared from the frothed dispersions will have a density of 35 kg/m³ to 160 kg/m³. Preferably the foam will have a density of 40-150 kg/m³. More preferably the foam will have a density of 50-120 kg/m³. Most preferred is a foam having a density of 60-80 kg/m³.

Surfactants useful for preparing a froth are referred to herein as frothing surfactant. A frothing surfactant allows the gas, commonly air, used in frothing to disperse homogenously and efficiently into the formulated foamed dispersion. Preferably the frothing surfactant produces a non sudsing composite foam product after drying.

Frothing surfactants for preparing the low density foams of the present invention can be chosen from anionic, cationic or zwitterionic. An example of a generally used anionic surfactant is sodium lauryl sulfate, however this surfactant has the disadvantage of post sudsing in the final foam product. Preferably the frothing surfactant is a carboxylic acid salts. Such surfactants can be represented by the general formula

RCO₂⁻X⁺ (Formula 1),

where R represents a C₈-C₂₀ linear or branched alkyl, which can contain an aromatic, a cycloaliphatic, or heterocycle; and X is a counter ion. Generally X is Na, K, or an amine, such as NH₄⁺, morpholine, ethanolamine, triethanolamine, etc.

Preferably R is from 10 to 18 carbon atoms. More preferably R contains from 12-18 carbon atoms. The surfactant can contain a plurality of different R species, such as a mixture of C₈-C₂₀ alkyl salts of fatty acids. Preferably X is an amine. More preferably the surfactant is an ammonium salt, such as ammonium stearate.

The amount of frothing surfactant(s) used is based on the dry solids content in the surfactant relative to polyurethane dispersion solids in parts per hundred. Generally, 1 to 15 parts of dry surfactant are used per hundred parts of polyurethane dispersion. Preferably 1 to 10 parts of dry surfactant are used per hundred parts of polyurethane dispersion. More preferably 1 to 5 of dry surfactant are used per hundred parts of polyurethane dispersion. Using higher levels of frothing surfactants while reducing levels of stabilizing surfactants is possible but not desirable due to the increase addition of water at the same time. In addition high levels of surfactant have other deleterious effects on foam composites such as increased fogging and increased soiling.

Surfactants useful for preparing a stable froth are referred to herein as stabilizing surfactant. The stabilizing surfactant used for producing the low density foam of the present invention is based on sulfonic acid salts, such as sulfates such as alkylbenzenesulfonates, succinamates, and sulfosuccinamates. Preferred sulfates are the class of sulfosuccinate esters which can be represented by the general formula

R²OOCCH₂CH(SO₃⁻M⁺)COOR² (Formula 2)

where R² at each occurrence is independently a C₆-C₂₀ linear or branched alkyl, which can contain an aromatic, a cycloaliphatic and M is a counter ion.

Generally M is ammonia or a or a member from group 1A of the Periodic Table, such as lithium, potassium, or sodium. Preferably R² is from 8 to 20 carbon atoms. More preferably R² contains from 10 to 18 carbon atoms. The surfactant can at each occurrence contain a different R² species. Preferably R is an amine. More preferably the surfactant is an ammonia salt. Preferably the stabilizing surfactant is a salt of an octadecyl sulfosuccinate. Generally, 0.01 to 20 parts of dry surfactant are used per hundred parts of polyurethane dispersion. Preferably 0.05 to 10 parts of dry surfactant are used per hundred parts of polyurethane dispersion. More preferably 0.1 to 6 of dry surfactant are used per hundred parts of polyurethane dispersion.

In addition to the combination of anionic surfactants given above, preferably the Compound will also contain a zwitterionic surfactant to enhance frothing and/or stability of the froth. Preferred zwitterionic sufactants are N-alkylbetaines, preferred are the beta-alkylproprionic acid derivatives. The N-alkylbetaines can be represented by the general formula Such surfactants can be represented by the general formulas:

R³N⁺(CH₃)₂CH₂COO⁻M⁺ (Formula 3)

R₃N⁺ Cl⁻ M+ or (Formula 4)

R₃N⁺ Br⁻ M⁺ (Formula 5)

where R³ is a C₆ to C₂₀ linear or branched alkyl, which can contain an aromatic, a cycloaliphatic and R and M are as described above. When used, generally 0.01 to 5 parts of dry zwitterionic surfactant are used per hundred parts of polyurethane dispersion. Preferably 0.05 to 4 parts of dry surfactant are used per hundred parts of polyurethane dispersion.

The anionic and zwitterionic surfactants given above are commercially available.

In addition to the above listed surfactants, other surfactants can be used which do not detrimentally affect the frothing or stability of the forth. In particular additional anionic, zwitterionic or nonionic surfactants may be used in combination with the above listed surfactants.

In addition to a polyurethane dispersion, frothing and stabilizing surfactants, it is preferred that the Compound contains a flame retardant. It has been surprisingly found that the level of inorganic filler and desired physical properties of a final foam can be obtained by the combination of anionic and Zwitterionic surfactants as given above. The combination of surfactants aid the dispersion stability of the filler in the Compound and do not negatively affect froth and foam stability.

Flame retardants which can be added to the Compound include those typically used to give enhanced flame retardant properties to a typical latex foam. Such flame retardants include phosphonate esters, phosphate esters, halogenated phosphate esters or a combination thereof. Representative examples of phosphonate esters include dimethylphosphonate (DMMP) and diethyl ethylphosphonate (DEEP). Representative examples of phosphates esters include triethyl phosphate and tricresyl phosphate. When used the phosphonate or phosphate ester flame retardants are present in the final foam at a level of from 0.5 to 10 percent by weight of the final foam.

Representative examples of halogenated phosphate esters include 2-chloroethanol phosphate (C₆H₁₂Cl₂O₄P); 1-chloro-2-propanol phosphate [tris(1-chloro-2-propyl) phosphate] (C₉H₁₈Cl₃O₄P) (TCPP); 1,3-Dichloro-2-Propanol Phosphate (C₉H₁₅Cl₆O₄P) also called tris(1,3-dichloro-2-propyl) phosphate; tri(2-chloroethyl) phosphate; tri (2,2-dichloroisopropyl) phosphate; tri (2,3-dibromopropyl) phosphate; tri(1,3-dichloropropyl)phosphate; tetrakis(2-chloroethyl)ethylene diphosphate; bis(2-chloroethyl) 2-chloroethylphosphonate; diphosphates [2-chloroethyl diphosphate]; tetrakis(2-chloroethyl) ethylenediphosphate; tris-(2-chloroethyl)-phosphate, tris-(2-chloropropyl)phosphate, tris-(2,3-dibromopropyl)-phosphate, tris(1,3-dichloropropyl)phosphate tetrakis (2-chloroethyl-ethylene diphosphate and tetrakis(2-chloroethyl) ethyleneoxyethylenediphosphate. When used as a flame retardant, the halogenated phosphate ester will comprise 0.5 to 10 percent by weight of the final foam.

Preferred flame retardants for use with the present dispersion are dehydratable flame retardants, some of which have been used as fillers for certain products. Such flame retardants include alkali silicates, zeolites or other hydrated phosphates, borosilicates or borates, alumina hydroxides, cyanuric acid derivatives, powdered melamine, graphites and mica which are capable of swelling, vermiculites and perlites, and minerals containing water of crystallization such as aluminohydrocalcite, hydromagnesite, thaumasite and wermlandite. Al₂O₃3H₂O Alumina trihydrate, also known as aluminum hydrated oxides or hydrated alumina, are preferred.

The dehydratable flame retardant is generally added to the polyurethane dispersion in an amount of from 5 to 120 parts per 100 parts dispersion solids of the final Compound. Preferably the flame retardant is added in an amount from 20 to 100 parts per 100 parts dispersion solids of the final Compound. More preferably the flame retardant is added in an amount from 50 to 80 parts per 100 parts dispersion solids of the final Compound.

The use of such dehydratable flame retardants allows the production of composite materials containing a polyurethane which meet certain flammability tests, such as FMVSS 302, without the need for use of a halogenated flame retardant. The Compounds can be applied to textiles where the textile itself meets the required combustion modification test. In such a case, there is no detrimental effect on the combustion modification performance and generally the combustion modification properties are improved. When the foamed Compound is added to a textile which itself does not meet a specific flammability test, the use of the foamed Compound with a dehydratable flame retardant generally enhances the combustion modification properties of the final composite.

Examples of conventional fillers include as milled glass, calcium carbonate, aluminum trihydrate, talc, bentonite, antimony trioxide, kaolin, fly ash, or other known fillers. In the practice of the present invention, a suitable filler loading in a polyurethane dispersion can be from 0 to 200 parts of filler per 100 parts of dispersion solids (pphds) of the final Compound. Preferably, filler can be loaded in an amount of less than about 100 pphds most preferably less than about 80 pphds. Addition of inorganic fillers enhances the production of the foam composite by faster drying speeds on the production line since the percentage of water in the Compound which has to be removed on drying is lower.

Optionally a filler wetting agent can be present. A filler wetting agent can generally improve the compatability of the filler and the polyurethane dispersion. Useful wetting agents include phosphate salts such as sodium hexametaphosphate. A filler wetting agent can be included in a Compound of the present invention at a concentration of at least about 0.5 pphds.

In addition to a polyurethane dispersion, combustion modifier and a foam stabilizer, a Compound of the present invention can optionally include: cross-linkers, which are different chemical entities than those generally used in the polyurethane dispersion preparation, (epoxy resins as reactive agents or as a water dispersion, water dispersable isocyanate, low reactivity aliphatic isocyanate), fillers; dispersants; thickeners; absorbents; fragrances and/or other materials known in the art to be useful in the preparation of polymer foam products. The term “Compound” particularly means the material placed into a mechanical frothing unit to produce a froth which can be dried to form a stable foam.

The present invention optionally includes thickeners. Thickeners can be useful in the present invention to increase the viscosity of low viscosity polyurethane dispersions. Thickeners suitable for use in the practice of the present invention can be any known in the art. For example, suitable thickeners include ALCOGUM™ VEP-II (trade designation of Alco Chemical Corporation) and PARAGUM™ 241 (trade designation of Para-Chem Southern, Inc.). Other suitable thickeners include cellulose derivatives such as Methocel™ products (trade designation of The Dow Chemical Company). Thickeners can be used in any amount necessary to prepare a Compound of desired viscosity.

While optional for purposes of the present invention, some components can be highly advantageous for product stability and durability during and after the manufacturing process. For example, inclusion of antioxidants, biocides, and preservatives in the Compound can be highly advantageous in the practice of the present invention.

For preparing a froth from the Compound, a gaseous frothing agent is generally used. Examples of suitable frothing agents include: gases and/or mixtures of gases such as, for example, air, carbon dioxide, nitrogen, argon, helium. Frothing agents are typically introduced by introduction of a gas above atmospheric pressure into a liquid Compound to form a homogeneous froth by mechanical shear forces during a predetermined residence time, that is mechanical frothing. In preparing a frothed polyurethane backing, it is preferred to mix all components of the Compound and then blend the gas into the mixture, using equipment such as an OAKES, COWIE & RIDING or FIRESTONE frother.

Other types of aqueous polymer dispersions can be used in combination with the polyurethane dispersions of the present invention. Suitable dispersions useful for blending with polyurethane dispersions of the present invention include: styrene-butadiene dispersions; styrene-butadiene-vinylidene chloride dispersions; styrene-alkyl acrylate dispersions; ethylene vinyl acetate dispersions; polychloropropylene latexes; polyethylene copolymer latexes; ethylene styrene copolymer latexes; polyvinyl chloride latexes; or acrylic dispersions, like compounds, and mixtures thereof.

The polyurethane foams of the present invention are resilient. For purposes of the present invention, a resilient foam is one which has a minimum resiliency of 5 percent when tested by the falling ball method. This method, ASTM D3574 generally consists of dropping a ball of known weight from a standard height onto a sample of the foam of a specified height and then measuring the rebound of the ball as a percentage of the height from-which it was dropped. Preferably the foams of the present invention have a resiliency of from 5 to 80 percent, more preferably from 10 to 60 percent, and most preferably from 15 to 50 percent.

A polyurethane dispersion of the present invention can be stored for later application to the back of a substrate, such as, a textile, plastic films, synthetic sheets, such as PVC, paper, wood laminate flooring, construction panels like sheet rock and metal coils for profiled panels. Typically the polyurethane dispersion, usually in the form of a frothed Compound, is applied as a stable froth to a substrate surface using equipment such as a doctor knife or roll, air knife, or doctor blade to apply and gauge the layer, see for example, U.S. Pat. Nos. 5,460,873 and 5,948,500. In applying the froth to a textile, the textile is generally heated prior to the addition of the froth, see for example, U.S. Pat. No. 5,460,873. Preferably the textile is heated to 25 to 50° C. prior to application of the froth. Heating the textile is believed to lower the viscosity of the liquid froth which enhances penetration of the textile at the interface. Furthermore it is believed that heating the textile also impacts surface tension which improves compatibility between the froth and the textile.

After the froth is applied to a substrate, the material is treated in such a manner to remove substantially all of the water present in the froth, resulting in a material that is a composite containing a resilient polyurethane cellular foam. Removal of the water is generally done by use of a suitable energy source such as an infrared oven, a conventional oven , microwave or heating plates. Preferably drying is done by the addition of heat. Drying can be at ambient temperature but preferably is done in an oven at temperatures of from 50 to 200° C.

The amount of foamed Compound used to coat a textile can vary widely, ranging from 1.5 to 25 ounces per square yard (0.053 kg/m² to 0.85 kg/m²) dry weight, depending on the characteristics of the textile, the desired coating weight and thickness. For example, foams having a thickness of 3 to 6 mm, the preferred coating weight is from 2 to 12 ounces per square yard (0.0.067 kg/m²-0.4 kg/ m²) dry weight. For foam having a thickness of about 12 mm, the preferred coating weight is from 10 to 25 ounces per square yard (0.335 kg/m²-0.85 kg/m²) dry weight.

In preparing the polyurethane foam backed substrates of the present invention in general, and the backed textiles in particular, it is advantageous to dry the foamed polyurethane Compound as quickly as possible after it is applied to the substrate. It is particularly advantageous to do at least the initial drying of a foamed polyurethane Compound of the present invention using an infra-red heater as this practice can promote the formation of a smooth skin on the surface of the foam facing the heater which is both aesthetically desirable and may also be embossed or subjected to some other form of marking process.

To aid in placing of the foamed composite onto or over another material, it is advantageous to incorporate a ‘slip’ aid into the froth formulation or adding an additional slip layer before or after complete cure of the polyurethane foam. Such aids modify the friction coefficient properties of the foam surface and allow the composite to slide in place for easier handling. Such slip aids include laminated polyolefin films, sprayed on teflon coatings, silicones etc. Components which can be incorporated into the froth include waxes, particularly wax emulsions which are compatible with the various Compound components.

One property of the polyurethane foams of the present invention is that they are more resistant to yellowing. Conventional polyurethane foams, particularly those prepared with aromatic starting materials such as MDI or TDI, can yellow upon exposure to air and ultraviolet light. The foams of the present invention have a surprising ability to resist yellowing under conditions which would cause rapid yellowing in a conventional polyurethane foam.

In producing the Compound, the surfactants are generally added to the polyurethane dispersion along with antioxidants, bactericides etc. since viscosity is low and good mixing is obtained. The dipsersion aid should then be added followed by the inorganic filler, slowly enough to ensure good dispersion and avoid clumping/lumping of the filler. Finally the thickener is added to the required compound viscosity. In the present application, it is believed that the addition of ammonium stearate after the filler and thickener addition avoids swelling of the polyurethane dispersion particle resulting in a lower Compound viscosity during mixing.

The following examples are provided to illustrate the present invention. The examples are not intended to limit the scope of the present invention and should not be so interpreted. All percentages are by weight unless otherwise noted.

### EXAMPLES

Materials Used in the Examples:

| | |
|---|---|
| VORANOL* 4701 | A 4950 molecular weight triol having 15 percent |
| | EO capping (* Trade designation of The Dow |
| | Chemical Company). |
| ISONATE* 125M | 4,4′-methylene diphenyl isocyanate having a |
| | functionality of 2.0 and an equivalent weight of |
| | 125 g/equivalent (* Trade designation of The Dow |
| | Chemical Company). |
| ISONATE* 50 OP | A 50 percent 4,4′-methylene diphenyl isocyanate, |
| | 50 percent 2,4′methylene diphenyl isocyanate |
| | mixture having a functionality of 2.0 and an |
| | equivalent weight of 125 g/equivalent (* Trade |
| | designation of The Dow Chemical Company). |
| MPEG* 950 | Monol produced by reacting ethylene oxide with |
| | methanol to an equivalent weight of 950 g/ |
| | equivalent (* Trade designation of The Dow |
| | Chemical Company). |
| BIO-TERGE* | Mixed olefin (C14-16) sodium sulfonate (*Trade |
| AS-40 | designation of Stepan Corporation). |
| EMPIM1N MK/B* | Di sodium N-tallow sulphosuccinamate available |
| | as a 35 percent active solution in water (* Trade |
| | designation of Albright & Wilson UK). |
| ACUSOL* A810 | Acrylate thickener available as a 19 percent |
| Thickener | solution in 1 water (* Trade designation of Rohm |
| | and Haas Co). |
| Antioxidant L: | an emulsion of 54 parts (3,(3- |
| | ditrydecylthiodipropionate, 40 parts water, and 6 |
| | parts WINGSTAY L. |
| WINGSTAY* L | a butylated reaction product of p-cresol and |
| | dicyclopentadiene (* Trade designation of |
| | Goodyear Rubber Company). |

Preparation of a Prepolymer:

A prepolymer is prepared by adding 504 g of VORANOL 4701, 14 g MPEG 950, 9.19 g diethylene glycol, 86.45 g ISONATE 125M, and 86.45 g ISONATE 50 OP into a glass bottle wherein the threads of the glass bottle are wrapped with TEFLON* tape to prevent the lid from adhering to the bottle (*A trade designation of DUPONT). The bottle is sealed, shaken vigorously until homogeneity of the components is achieved, and then rolled on a bottle roller for about 10 minutes. The bottle is then placed in an oven held at 70° C. for 15 hours, whereupon it was removed and allowed to cool to room temperature prior to use.

Preparation of an Aqueous Polyurethane Dispersion

A polyurethane dispersion is prepared by chain extending the prepolymer in water with piperazine to a stoichiometry of 0.75 to a solids content of 52.7 percent. The dispersion is prepared with 3 percent BIO-TERG AS-40 surfactant, based on prepolymer solids. The polyurethane dispersion has a volume average particle size of 0.229 micron.

### Example 1

Preparation of a Low Density Resilient Polyurethane Frothed Foam:

The following compound shown in Table I. is prepared at room temperature and allowed to stand for approximately one hour to allow for viscosity build.

TABLE I

| Order of | | Dry | Wet |
|---|---|---|---|
| addition | Raw Materials | Parts | Parts |
| 1 | Polyurethane Dispersion (as described above) | 90 | 164 |
| 2 | Terpolyomer of vinylidene chloride/styrene/ | 10 | 19.6 |
| | butadiene polymer in water | | |
| 3 | Stanfax 234 (sodium lauryl sulfate in water); | 3 | 10.1 |
| | primary foaming surfactant | | |
| 4 | Stanfax 318 (disodium octadecyl | 1 | 3 |
| | sulfosuccinamate in water); foam stabilizer | | |
| 5 | Stanfax 590 (cocoamidopropyl betaine in | 1 | 2.6 |
| | water); foam booster | | |
| 6 | Octolite 640-60 (synergistic blend of polymeric | 0.6 | 1 |
| | hindered phenol and thioester); | | |
| | antioxidant emulsion | | |
| 7 | Acusol 810 A | 0.2 | 1 |

The compound is frothed using an Oakes Laboratory Mixer (E. T. Oakes Corporation; Hauppauge, N.Y.), to a density of approximately 110 grams per liter and cast onto an uncoated non-woven polyester fabric to a thickness of 3.6 millimeters. The foam is dried for 10 seconds under infrared heat followed by 20 minutes in an oven at 143° C. The results of foam testing are listed below in Table III.

### Example 2

Preparation of a Low Density Resilient Polyurethane Frothed Foam for Flame Resistant Applications:

The following compound shown in Table II. is prepared at room temperature and allowed to stand for approximately one hour to allow for viscosity build.

TABLE II

| Order of | | Dry | Wet |
|---|---|---|---|
| addition | Raw Materials | Parts | Parts |
| 1 | Polyurethane Dispersion (as described above) | 100 | 181 |
| 2 | Alumina Trihydrate, standard grade | 90 | 90 |
| 3 | Stanfax 318 | 1 | 3 |
| 4 | Stanfax 590 | 1 | 2.6 |
| 5 | Octolite 640-60 | 0.6 | 1 |
| 6 | Stanfax 320 (ammonium stearate); | 3 | 9.4 |
| | primary foaming surfactant | | |
| 7 | Acusol 810 A | 0.1 | 0.5 |

The Compound of Table II is frothed using an Oakes Laboratory Mixer (E. T. Oakes Corporation; Hauppauge, N.Y.) to a density of approximately 110 grams per liter. The froth is then cast to a thickness of approximately 3.5 millimeters onto an uncoated non-woven polyester fabric. The fabric should be warm (25-50° C.) during the casting process. The foam is then dried for 5 to 10 seconds under infrared heat followed by 20 minutes in a convention oven at 143° C. Results of foam are listed below in Table III.

TABLE III

| | Example 1 | Example 2 |
|---|---|---|
| Foam Density (g/cc) ASTM D-3574 | 0.064 | 0.080 |
| Resilience - minimum (percent) ASTM D-3574 | 29 | 32 |
| Foam Resilience - maximum (percent) | 35 | 33 |
| ASTM D-3574 | | |
| Foam Tensile (kPa) ASTM D-3574 | 227 | 117 |
| Foam Elongation at break (percent) ASTM D- | 249 | 225 |
| 3574 | | |
| Composite Peel Adhesion - 180 degree | 4 | 3.6 |
| (N/25 mm) | | |
| Composite FMVSS302 - Avg. burn rate | 88.9 | 35.6 |
| (mm./min.) | | |

### Example 3

Preparation of a Low Density Resilient Polyurethane Frothed Foam for Flame Resistant Applications:

The following compound shown in Table IV. is prepared at room temperature and allowed to stand for approximately one hour to allow for viscosity build.

TABLE IV

| Order of | | Dry | Wet |
|---|---|---|---|
| addition | Raw Materials | Parts | Parts |
| 1 | Polyurethane Dispersion (as shown above) | 100 | 181 |
| 2 | Alumina Trihydrate, standard grade | 75 | 75 |
| 3 | Stanfax 318 | 1 | 3 |
| 4 | Stanfax 590 | 1 | 2.6 |
| 5 | Octolite 640-60 | 0.6 | 1 |
| 6 | Stanfax 320 | 3 | 9.4 |
| 7 | Acusol 810 A | 0.1 | 0.5 |

The compound described in Table IV was cast onto a commercial grade polyester fabric. Samples of the fabric were tested for flammability resistance in accordance with FMVSS 302 before the coating was applied. Foam/fabric composites were also tested for flammability resistance following drying. Test results are given in Table V.

TABLE V

| | | Composite |
|---|---|---|
| | Fabric A | Fabric A |
| Foam Density (g/cc) ASTM D-3574 | NA | 0.076 |
| Composite Peel Adhesion - 180 degree | NA | 3.1 |
| (N/25 mm) ASTM D-751 | | |
| FMVSS302 - Avg. burn rate (mm./min.) | 109 | 50 |
| Note: Maximum allowable burn rate <100 mm./ | | |
| min. | | |

Although the invention has been described in detail in the foregoing for the purpose of illustration, it is to be understood that such detail is solely for that purpose and-that variations can be made therein by those skilled in the art without departing from the spirit and scope of the inventions.

What is claimed is:

1. A process for making a two or more component foam composite obtained by adhesion of a polyurethane foam onto a substrate comprising the steps of frothing an aqueous polyurethane formulation; applying the froth to a substrate and drying the froth into a foam wherein the foam has a dry density of 35 kg/m³ to 160 kg/m³ (2.2-10 lbs/cft) wherein the polyurethane formulation is prepared from a polyurethane dispersion, a frothing surfactant and a stabilizing surfactant.

2. The process of claim 1 wherein the polyurethane dispersion is prepared by admixing water, a chain extender, a sufactant, a polyurethane prepolymer under mixing conditions sufficient to prepare a stable dispersion.

3. The process of claim 2 wherein the surfactant is an anionic surfactant.

4. The process of claim 1 wherein the frothing surfactant is a carboxylic acid salt.

5. The process of claim 4 wherein the frothing surfactant is one or more surfactants of the formula:
RCO₂⁻X⁺ (Formula 1),
where R represents a C₈-C₂₀ linear or branched alkyl, which can contain an aromatic, a cycloaliphatic, or heterocycle; and X is a counter ion.

6. The process of claim 5 wherein X⁺ is Na, K, or an amine.

7. The process of claim 6 wherein X⁺ is NH₄⁺.

8. The process of claim 4 wherein the surfactant is present in an amount of 1 to 15 parts dry weight surfactant per 100 parts of polyurethane dispersion solids.

9. The process of claim 7 wherein the surfactant is ammonium stearate.

10. The process of claim 1 wherein the stabilizer surfactant is an anionic surfactant based on at least one sulfonic acid salt.

11. The process of claim 10 wherein the stabilizing surfacting is one or more surfactants of the formula:
R²OOCCH₂CH(SO₃⁻M⁺)COOR² (Formula 2)
where R² at each occurrence is independently a C₆-C₂₀ linear or branched alkyl, which can contain an aromatic or a cycloaliphatic and M is a counter ion.

12. The process of claim 11 wherein M is ammonia or a member from Group 1A of the Periodic Table.

13. The process of claim 12 wherein the surfactant is a salt of of octadecyl sufosuccinate.

14. The process of claim 11 wherein the stabilizing surfactant is present in an amount of 0.01 to 10 parts of dry surfactant per 100 part of polyurethane dispersion solids.

15. The process of claim 1 wherein the formulation contains a flame retardant such that the foam composite meets combustion modification test FMVSS 302.

16. The process of claim 15 wherein the flame retardant is a phosphonate ester, phospate ester, halogenaed phosphate ester, dehydratable flame retardant or a mixture thereof.

17. The process of claim 16 wherein the flame retardant is a dehydratable flame retardant selected from from alkali silicates, zeolites or other hydrated phosphates, borosilicates or borates, aluminum hydroxides, cyanuric acid derivatives, phenol, melamine or urea formaldehyde resins, graphites and mica which are capable of swelling, vermiculites and perlites.

18. The process of claim 17 wherein the flame retardant is retardant is an aluminum hydroxide, aluminum hydrated oxides, hydrated alumina, or a mixture thereof.

19. The process of claim 17 wherein the flame retardant is present in an amout of 5 to 120 parts per 100 parts of dispersion solids.

20. The process of claim 1 wherein the substrate is selected from a textile, plastic film, synthetic sheet or paper.

21. The process of claim 20 wherein the substrate is a polyvinyl sheet.

22. The process of claim 20 wherein the substrate is a textile.

23. A textile fabric-flexible polyurethane composite comprised of a woven fabric, the fabric having been coated on at least one side with a flexible foam having a dry density of 35 kg/m³ to 160 k/m³ where the foam is derived from a frothed polyurethane composition comprising a polyurethane dispersion, surfactants and other additives known per se for producing such flexible polyurethane foams.

24. The composite of claim 23 wherein the surface properties of the foam are modified by inclusion of a wax in the frothed polyurethane composition at a preferred level of 1.0 to 10.0 parts per 100 parts of dispersion solids.

25. The composite of claim 23 wherein the surface properties of the foam opposite the surface attached to the fabric is modified by application of a silicone polymer, preferably as a water based emulsion or dispersion, through a spray process or a roller coating process.

26. The composite of claim 23 wherein a light weight non-woven polyethylene is applied to the flexbile foam by a heat laminating process at pressures and temperatures which do not negatively affect the textile or foam in producing the 3 component composite.
